(19) United States
(12) Patent Application Publication
(10) Pub. No.: US 2007/0260466 A1
(43) Pub. Date: Nov. 8, 2007

(54) System and methods for a recycling program

(75) Inventors: John W. Casella, Rutland, VT (US); Sean Duffy, Huntersville, NC (US); S. Graham Stevens, Charlotte, NC (US)

Correspondence Address: Kevin M. Farrell;Pierce Atwood, Suite 350, One New Hampshire Avenue, Portsmouth, NH, 03801, US

(73) Assignee: Casella Waste Systems, Inc., Rutland, VT (US)

(21) Appl. No.: 11/387,076

(22) Filed: Mar. 20, 2006

(51) Int. Cl. G06Q 10/00; G06Q 30/00

(52) U.S. Cl. 705/1

(57) ABSTRACT

A system and methods for managing a recycling program including the step of receiving waste materials from a user and the step of receiving recyclable materials from the user. Further, the step of measuring a quantity of waste materials received and the step of measuring a quantity of recyclable materials received. Further still, calculating a user-specific diversion rate based upon the ratio of recyclable materials as compared to the sum of recyclable materials and waste materials. The instant abstract is neither intended to define the invention disclosed in this specification nor intended to limit the scope of the invention in any way.

### BACKGROUND OF THE INVENTION

1. Field of the Invention

The present invention relates generally to environmental protection and sustainability, and more specifically to systems and methods for improving the recycling behavior of various entities.

2. Discussion of Background Information

Recycling programs have become more commonplace in the United States and other developed countries through the end of the twentieth century and the beginning of the twenty-first century as consumers, businesses and governments realized the environmental and economic savings to be generated through recycling of goods. The most commonly known recyclable materials are paper, corrugated boards, aluminum, steel and other sheet metals, batteries and certain chemical compounds, plastics of varying types and glass. The implementation of higher technology automated equipment in material recovery facilities (MRFs) has further enabled a large volume of material to be collected, sorted and recovered with increasing speed and efficiency.

In spite of the improvements in recycling throughout the past twenty years, the overall rate of consumption of goods still greatly outpaces the rate at which recyclable materials are reintroduced into the stream of goods. This increased consumer and business demand for goods will continue to strain the economic and environmental resources of various countries and eventually the global community at large. What is needed therefore is a mechanism by which the incentives to recycle are increased dramatically for individuals, businesses, communities and government entities.

Several attempts have been made in the past decade to provide numerous incentives for recycling for individuals. For example, Japanese laid open patent applications 2002-297840 (2001) and 2005-008339 (2003) are typical of those types of systems that measure an individuals recycling behavior and, through an integrated system of measurement, analysis and reward, provide incentives for said individuals to increase their gross recycling. However, although these types of inventions are useful in the abstract, they do not address the issue as to the quality of those goods recycles. By merely creating incentives to recycle, the state of the art increases the probability that users will try to recycle goods that are not fit for processing in order to retain rewards or other benefits. In particular, as the state of the art measures the quantity of recyclable materials by mass quantity only, there is a significant incentive for users to overweight their containers using low-quality or non-recyclable materials in order to obtain the greater benefits.

With respect to the present invention, the point of departure from the prior art lies in the electronic capture of data relating to individual recycled items, and the electronic association of this data with a user from whom the recyclables are received. According to an aspect of the present invention, a wealth of knowledge can be gained from the mining of this electronic data, and this information can be used for a variety of purposes. For example, information relating to the recycling behavior of a user of a recycling system can be used to promote, based on incentive, improved recycling behavior. As will be discussed in greater detail below in connection with specific figures, such rewards can be provided in a variety of formats. As a general proposition to the present invention, it will be recognized that the electronic capture of data relating to individual recycled items received from a user can be recorded, and improvement in recycling behavior by the user can be rewarded over time.

Further still, with respect to the present invention, electronic data capture can be accomplished in a variety of ways, as will be discussed in greater detail in connection with specific figures below. Some forms of electronic data capture will provide information relating to the type of material being recycled (e.g., glass, aluminum, specific types of plastics, etc.) according to an aspect of the invention. Further, in many instances, the identity of the manufacturer who placed the product associated with the recycled material into the stream of commerce may be identifiable. For example, using optical recognition software, electronic images of recyclables from a user's recycling container may be scanned and the corporate entity associated with the product originally packaged in the recyclable identified. Information of this type is of great value to the corporate entity referred to in the preceding sentence. For example, information relating to the success of a geographic marketing program can be directly assessed.

Also, with respect to the present invention, recyclables received are associated with a user. The user may be an individual, group of individuals or a user consortium such as a family, a classroom in a school, residents of a particular apartment building, one or more municipalities, groups of one or more businesses, any individual or group (or any combination thereof) etc. The recyclables according to the instant invention may be received from a conventional curbside recyclables container or tote. Alternatively, the recyclables may be received at a transfer station in situations where curbside recycling is impractical due to population density considerations (e.g., in urban areas or in rural areas).

Further still, with respect to the present invention, recyclables received are associated with a user, and this association is recorded electronically. For example, in a curbside recycling environment, the recyclables container may bear an RFID tag, which can be identified by a reader at the time of pickup. Alternatively, the present invention may provide, in the absence of specific RFID tags, GPS data that may be recorded which identifies the specific location of the pickup vehicle at the time that a particular recycling container is picked up. The user may be inferred from the GPS data in this context. In the rural or urban settings in which curbside pickup is impractical, a user may according the present invention be associated with recyclables through the presentation of an identification card or key fob which may be read electronically by a card reader or bar code scanner at a transfer station. These few examples are not intended to be limiting—one skilled in the art will recognize many ways in which received recyclables can be electronically associated with a particular user or user consortium.

What is needed therefore is a system or method of inducing recycling that has the added and essential benefit of reducing the overall consumption of non-recyclable goods, while simultaneously providing a streamlined system or method through which a user can be easily rewarded for its behavior.

### SUMMARY OF THE INVENTION

Accordingly, the present invention includes a system and methods for managing a recycling program that addresses the consumption and disposal of non-recyclable goods. Namely, the present invention increases the incentive for users of all types to increase their recycling while simultaneously providing a disincentive for users to consume and dispose of non-recyclable goods. Each aspect of the present invention is premised on a measurement of a user's diversion rate, which is defined herein as the ratio of a user's quantity of recyclables as compared to the quantity of recyclables and waste material. In summary, the diversion rate is a means through which one can measure the overall efficiency of a user's behavior, i.e. how much the user recycles as compared to its total consumption of goods.

$$User ' s diversion rate = \frac{User ' s quanitity of recyclables}{Quantity of recyclables and waste material}$$

The present invention generally includes a system and methods for managing a recycling program. The system and methods, each include means and steps for receiving waste materials from a user, receiving recyclable materials from a user, measuring a quantity of each type of material, and calculating a user-specific diversion rate based upon the ratio of the recyclable materials as compared to the sum of the recyclable and waste materials. In accordance with the system described in great detail below, the collection and measurement process is carried out by a plurality of collection vehicles and/or trucks, which network with a central computer and a series of MRFs. The networking aspect of the present invention, for example can provide for the optimization of the routes of the vehicles as well as optimization of the MRFs expecting the recyclable materials.

Both the system and methods of the present invention are equally suited for all types of collection programs, for example municipal-directed collection programs and subscription-based programs. Further, benefits of the present invention can be directly accounted to users of all types of collection programs, including the types discussed above. For example, as the system and methods of the present invention can be applicable to transfer station and drop locations located in a rural area. For example, as the system and methods of the present invention can be applicable to municipal programs and other collection entities, there are special types of incentives (as detailed below) that permit a municipality (and other collection entities) with a high aggregate diversion rate for all of its users to convert the increase in recycling into an emission credit and/or environmental attributes usable by the municipality and other collection entities. Likewise, commercial users can be the beneficiaries of other aspects of the present invention including a certification of compliance with certain environmental management standards based upon their diversion rates.

The instant invention is directed to a method for managing a recycling program including: a) receiving waste materials from a user; b) receiving recyclable materials from the user; c) measuring a quantity of waste materials received; d) measuring a quantity of recyclable materials received, and e) calculating a user-specific diversion rate based upon the ratio of recyclable materials as compared to the sum of recyclable materials and waste materials.

According to another embodiment of the invention, A recycling management system including: a) receiving and/or collecting waste materials from a user; b) receiving and/or collecting recyclable materials from the user; c) determining a quantity of waste materials received; d) determining a quantity of recyclable materials received; e) calculating a user-specific diversion rate based upon the ratio of recyclable materials as compared to the sum of recyclable materials and waste materials; and f) receiving one or more quality-material report derived from stored data relating to the quantity of recyclable materials and quantity of waste materials received from the user, such that the user is able to influence the user-specific diversion rate.

According to another embodiment of the invention, A system for managing a recycling program including: a) receiving waste materials from a user; b) receiving recyclable materials from the user; c) measuring a quantity of waste materials received; d) measuring a quantity of recyclable materials received; and e) calculating a user-specific diversion rate based upon the ratio of recyclable materials as compared to the sum of recyclable materials and waste materials.

The details and specific preferred embodiments of the present invention are discussed below with reference to the following figures. Although specific by nature, the following detailed description should be understood to convey the exemplary use of the present invention, and by no means limit the scope thereof, which is defined by the claims that follow.

### BRIEF DESCRIPTION OF THE DRAWINGS

The present invention is further described in the detailed description which follows, in which like reference numerals represent similar parts throughout the several views of the drawings, and wherein:

FIG. 1 is a schematic block diagram of a system for managing a recycling program in accordance with the present invention.

FIG. 2 is a schematic block diagram of one aspect of the system for managing a recycling program shown in FIG. 1.

FIG. 3 is a schematic block diagram an aspect of the user system of the present invention.

FIG. 4 is a schematic block diagram of an aspect of a user interface with the system of the present invention.

FIG. 5 is a schematic block diagram of an aspect of a route control system in accordance with the present invention.

FIG. 6 is a schematic block diagram of an aspect of a facility optimization system in accordance with the present invention.

FIG. 7 is a schematic diagram of an aspect of a municipality divided into regions according to the system and methods of the present invention.

FIG. 8 is a flow chart depicting an aspect of a method for measuring a diversion rate for a user.

FIG. 9 is a flow chart depicting an aspect of a method for providing an incentive to recycle for a user in response to a calculated diversion rate.

FIG. 10 is a flow chart depicting an aspect of a method for providing an incentive to recycle for a user in response to a calculated diversion rate.

FIG. 11 is a flow chart depicting an aspect of a method for measuring municipal sustainability in response to a diversion rate.

FIG. 12 is a flow chart depicting an aspect of a method for pricing a municipal collection service in response to a diversion rate and an associated amount of emission credits.

FIG. 13 is a flow chart depicting an aspect of a method for certifying compliance with an international environmental standard in response to a calculated diversion rate.

FIG. 14 is a flow chart depicting an aspect of a method for managing a facility in response to a calculated diversion rate.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The present invention, according to its various aspects and embodiments, provides numerous solutions to the aforementioned problems relating to recycling. In particular, the present invention provides means through which a user, i.e., a recycling entity and/or collection entity, is encouraged to continue its recycling behavior through various rewards systems, economic benefits, and environmental incentives.

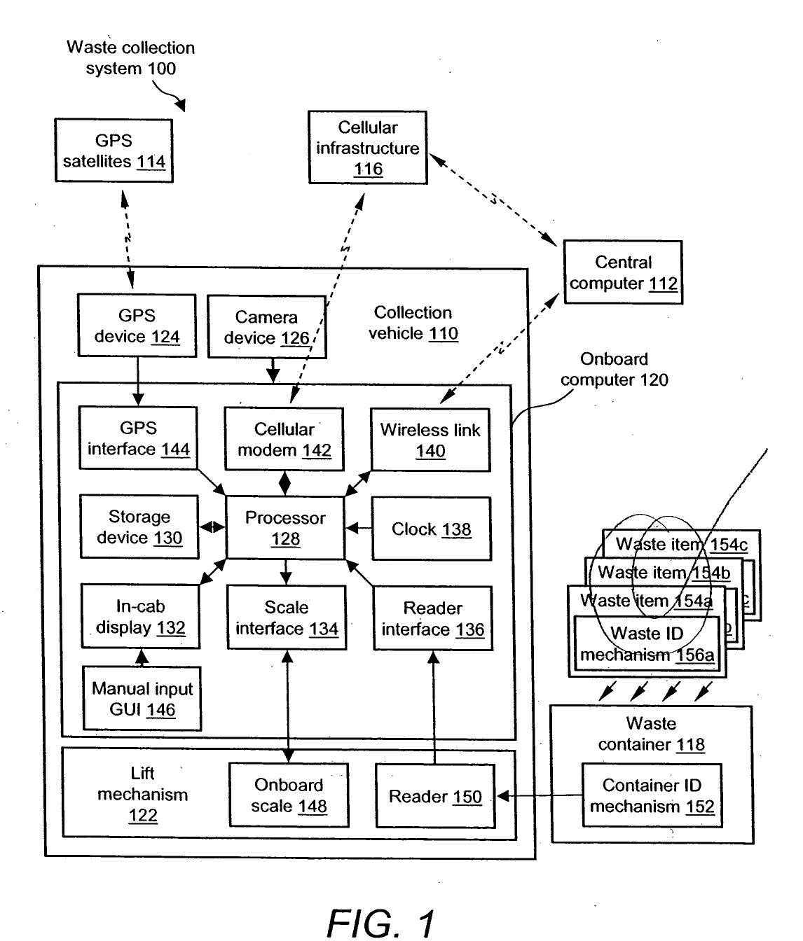

FIG. 1 shows by way of example a schematic block diagram of a system 100 for managing a recycling program in accordance with the present invention. The system 100 generally includes a collection vehicle 110 in communication with, preferably over wireless or cellular protocols, a central computer 112. The collection vehicle 110 can include at least one onboard computer 120 in communication with at least the central computer 110 and at least one cellular infrastructure 116 for facilitating communications there between. The onboard computer 120 can further be adapted for communication with at least one electronic monitoring device 126, for example but limited to one of a camera, optical sensor and a Global Positioning System (GPS) transceiver 124. Further, the GPS transceiver, in turn, can be communicable with one or more GPS satellites 114 for ascertaining the position of the collection vehicle 110.

According to the invention the collection vehicle 110 can preferably include a lift mechanism 122, such as a mechanical arm or similar device adapted to automatically maneuver a container 118, i.e., recyclables container, into a dumping position, whereby the contents of the container 118 are deposited into the collection vehicle 110. The lift mechanism 122 can preferably include an onboard scale 148 or other suitable weighing means for determining the contents of the container 118. For example, sensors and/or cameras may determine the volume of the recyclables container, or measured markings on the container, or other electronic or mechanical means that determine the amount of the recyclables delivered. The lift mechanism 122 can also be connected to or operate in concert with a reader 150 that is communicable with a container ID mechanism 152 disposable on the container 118. The container ID mechanism 152 can preferably be of the type permitting remote identification and transmission of identifying data, such for example but not limiting to one of a radio frequency identification (RFID) tag, a bar code, and any other suitable optical or electromagnetic identification means (and its associated electronics and circuitry).

According to several embodiments of the present invention, the system 100 is distributable over a network or grouping of collection vehicles 110 in communication with one or more central computers 112, which may be configured as one or more processors connectable to each other through the network. Likewise, the system 100 of the present invention 100 can be usable with any number of containers 118, wherein each container may be identified with a user through its respective container ID mechanism 152. Additionally, a user or group of users may require more than one container 118, for example one container may be designated for one of waste, recycling, compost and the like; thus multiple container ID mechanisms 152 can be electronically configured for identifying a single user or group of users.

According to another embodiment of the present invention, at least one onboard computer 120 of the system 100 can include a plurality of components known in the art, as well as selected components that are unique to the present invention. For example, a processor 128 may be coupled to a scale interface 134, adapted to communicate with the onboard scale 148, and a reader interface 136, adapted to communicate with the reader 150. The processor 128 can further be coupled to a GPS interface 144, adapted to communicate and receive data from the GPS device 124 that is indicative of the position of the collection vehicle 110. The processor 128 can be further coupled to a cellular modem 142 and a wireless link 140, each of which may provide a discrete or redundant communications link between the collection vehicle 110 and the central computer 112. A clock 138 and a storage device 130 may also be coupled to the processor 128, as well as an in-cab display 132 and a manual input GUI 146.

The storage device 130 is preferably of sufficient size to store electronic data relating to the time, location, quality and quantity of the materials received from each of the plurality of containers with which the collection vehicle interacts throughout an extended time interval. Moreover, the storage device 130 should be of sufficient size to store digital data received from the electronic monitoring device 126, such as for example video or picture data received at each stop made by the collection vehicle 110. Moreover, the data stored on the storage device 130 should be readily retrievable by the processor 128 and preferably transmittable in a compressed and encrypted format for communications with the central computer 112, through either a direct wireless link 140 or through the cellular infrastructure 116.

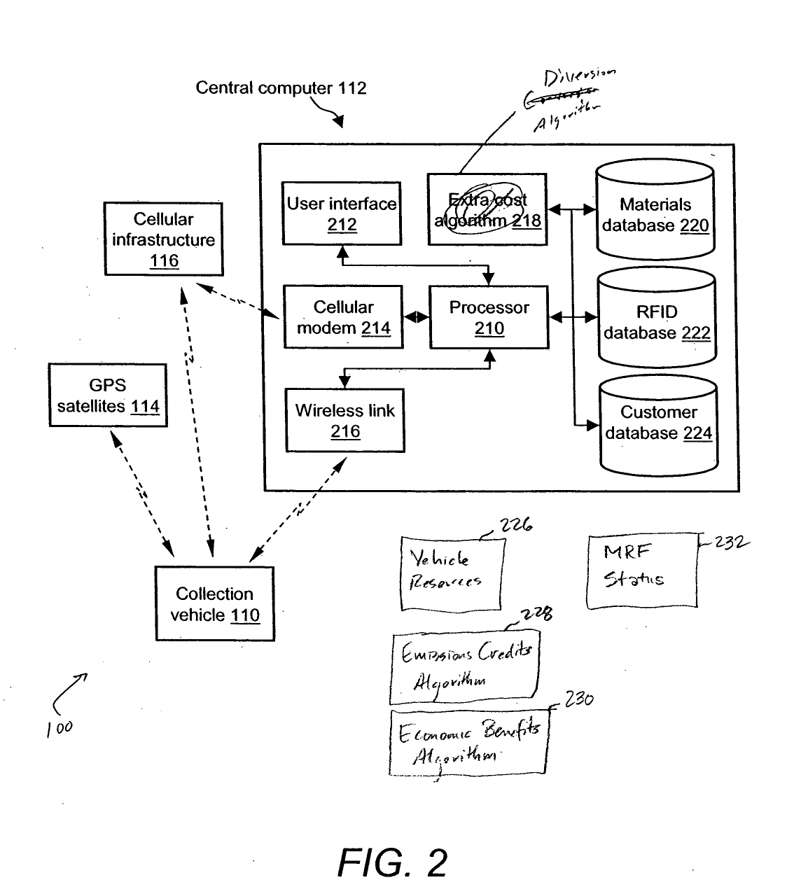

Aspects of the central computer 112 are shown schematically in FIG. 2. As shown herein, the central computer 112 is a unitary element, but it should be understood by those skilled in the art that the central computer 112 may also be a system or network of computers and databases that operate in concert to produce the functional results described herein. The central computer 112 may include at least a processor 210, a user interface 212, a cellular modem 214 and a wireless link 216. Moreover, the processor 210 can be connectable with or coupled to a materials database 220, a user ID database 222, and a customer database 224, all of which may be local or remote from the central computer 112 itself.

The central computer 112 also may include a vehicle resource center 226 and a material recovery facility (MRF) center 232, each of which provide real time or near real time updates regarding the position, configuration and load of the vehicle or MRF.

The central computer 112 also may include a plurality of modules or algorithms adapted to receive data inputs from the collection vehicle 110 and process that data into a result usable according to the present invention. Each of the following algorithms can be preferably encoded into one or more software applications that are executed by the processor 210 in the central computer 112, or alternatively in conjunction with the processor 128 on the onboard computer 120.

A diversion rate calculator 218 is included for calculating a diversion rate, defined as the ratio of recyclables received from a user as compared to the total volume of materials received from the user. The diversion rate calculator 218 cooperates with the central computer 112 for computing a diversion rate for an individual user and/or a group of users, based at least in part on data received by the collection vehicle 110 and its associated components described above. Further aspects of the diversion rate calculation are discussed below. The central computer 112 may include an emission credits calculator 228 and an economic benefits calculator 230, each of which operate in response to the diversion rate calculator 218, which provides as an input, a diversion rate for a user or group of users. The emission credits calculator 228 can be adapted to convert a user's diversion rate into an emission credit, usable by the user for demonstrating compliance with environmental regulations or receiving certain regulatory or governmental benefits for operating an environmentally friendly enterprise.

The economic benefits calculator 230 is adapted to convert a user's diversion rate into an economic benefit, such as for example a coupon, a discount on goods or services provided by third parties, or a discount on a municipal or subscription waste collection program. For example, the benefit to the user may be provided as a gift certificate usable by the user, and//or a credit to a user account. Another example of the benefit to the user may include an item of commercial value, a reward (designated in any form), or discounts to pricing on collection service, or any other transferable item that is of value to a residential user, commercial user, government user or consortium of users. In particular, the item of commercial value (a coupon or reward) usable by a user in the purchase of consumer or business goods, such as those found in retail stores. The item of commercial value can be deposited in the user account that could include an electronic coupon or rebate. Alternatively, for those users in rural settings, the item of commercial value may be directly deposited on the key fob or magnetic swipe card that the user uses for identification during the collection process. In such an instance, the item of commercial value may include a monetary credit directly applied to a magnetic swipe card, such as for example a credit or debit card commonly available and used frequently in commerce. Likewise, for other users, the item of commercial value may be a monetary credit directly applied to the user account, which may be associated with a debit card, credit card, or bank account associated with the user account for purposes of paying for the collection service. Alternatively, the item of commercial value may be a coupon or discount to be used for specific consumer or business products made by specified manufacturers and sold by specified retailers, wherein those products are commonly recycled, as determined by the system 100 and described above.

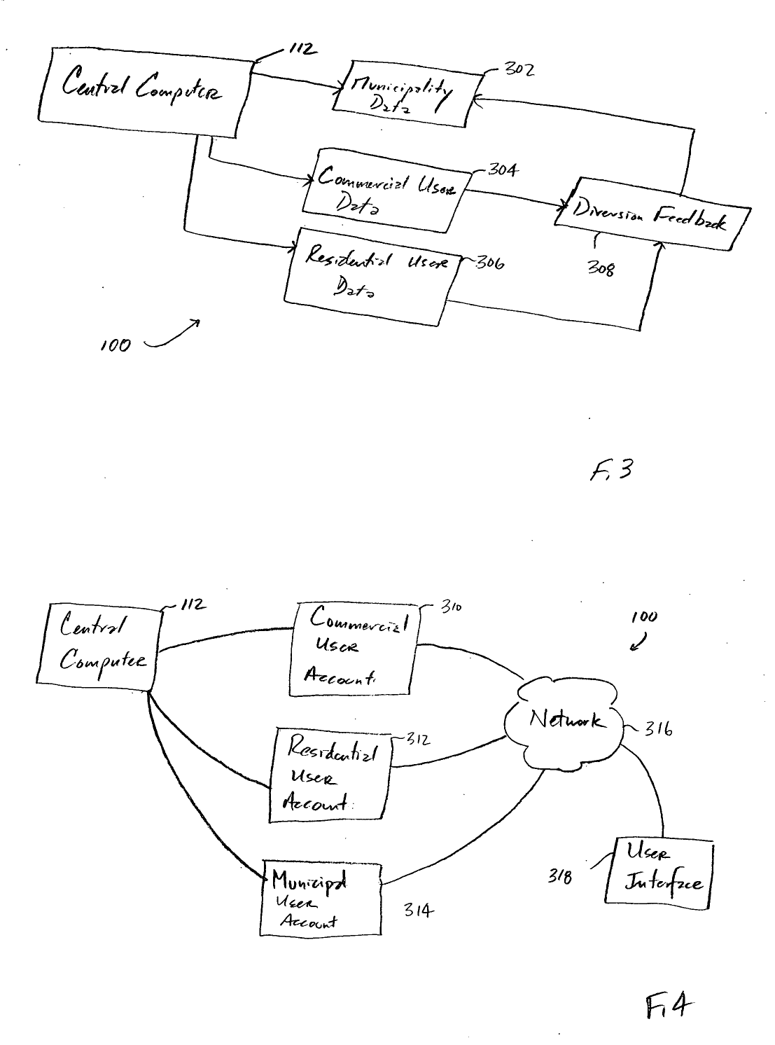

FIG. 3 shows by way of example a schematic block diagram illustrating aspects of the system 100 of the present invention that permit communication of diversion rate and other data to various entities. As shown, the central computer 112 is in communication with a plurality of databases relating to diversion rates, including commercial user data 304 and residential user data 306, as well as a municipality data 302 (other entity data is also possible). In various embodiments, the system 100 of the present invention can be adaptable for use in both municipal collection systems, subscription collection systems, as well as all other types of collection systems. Thus, the municipality can be a service provider, i.e. waste collector, a user, or the municipality can be both a collector and a user of a waste and recycling program. As such, the system 100 of the present invention further includes a diversion feedback module 308, preferably embodied in software operable on or with the central computer 112 that provides data to the municipality regarding the diversion rate of the various users therein. Thus, the diversion feedback module 208 provides at least data regarding the diversion rates for the commercial users and the residential users associated with the municipality.

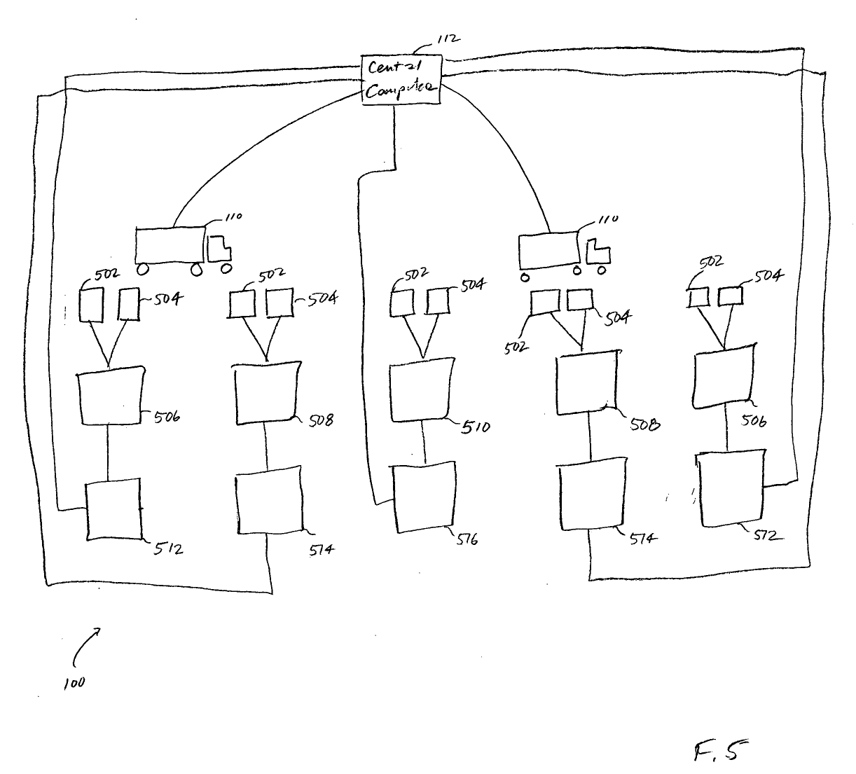

Interaction between the central computer 112 and the users can be facilitated by a network structure as shown in FIG. 4. For example, the central computer 112 is associated with a plurality of accounts, such as a commercial user account 310, a residential user account 312 and a municipal user account 314, each of which is accessible through a network 316 by a user having access to a user interface 318, such as a personal computer. As the central computer 112 retrieves and stores information and data relating to a user's diversion rate, and establishes a user account through which a user may view his or her diversion rate data, view any benefits received in response to the diversion rate data, and receive some benefits, i.e. coupons or rebates, provided to the user according to the present invention. Thus, in the case of a residential user, the residential user can access their assigned account, view their diversion rate data, and retrieve any benefits calculated according to the present invention. Likewise, a commercial user can access their assigned account, view their diversion rate data, and access and retrieve any benefits that may be due, such as pecuniary benefits, discounts, emission credits, and/or certifications of environmentally-sound operations. Moreover, the network 316 may be usable for directing benefits to a user's attention, as for example an email account associated with the user account in both the residential and commercial contexts. Further benefits can be immediately computed and directed or pushed to a user's attention through the network 316, along with the associated components as described above.

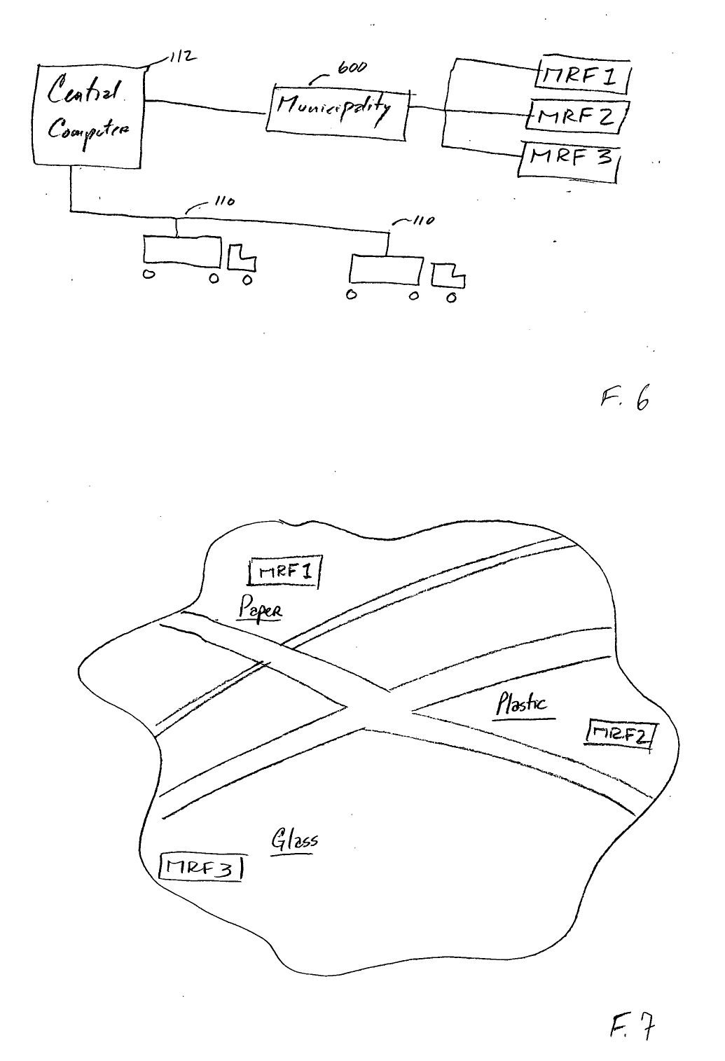

FIG. 5 shows by way of example a schematic block diagram of another aspect of the system 100 in accordance with the present invention. As noted above, the system 100 can be adapted for use by a plurality of different types of users, including residential users 506, commercial users 508, and user consortiums 510. For example, other user consortiums 510 may be understood to include governmental entities, apartment buildings, shared-service office buildings and the like. Each of the users depicted in FIG. 5 has a recyclables container 502 and a waste container 504, although it is noted that more than two types of containers are usable in the system 100 of the present invention. A plurality of collection vehicles 110 are shown in communication with the central computer 112, such that the central computer 112 can be coupled to a plurality of user accounts, including the residential user account 512, the commercial user account 514 and the consortium user account 516.

According to an aspect of the present invention, a collection vehicles 110 can proceed on a route, and collect both recyclables and waste from a plurality of users, as defined above. In practice, the recyclables and waste may be collected at substantially the same time or on differing days of the week. It is not uncommon for waste collection to occur on one day and recyclables collection to occur on a different day, especially in larger urban markets. As such, the diversion rate is not necessarily calculated in real time based on simultaneous inputs of waste and recyclable materials, but rather on a combination of real time data and historical data, i.e. the quantity of recyclables as measured currently and the quantity of waste as measured at a previous time. On the contrary, for those systems in which waste and recyclables are collected substantially simultaneously, the diversion rate for those users can be calculated in substantially real-time by the onboard computer 120 of the collection vehicle 110.

The system 100 components described above can permit the collection vehicle 110 to compute a diversion rate for each set of containers associated with a user account, i.e. the system 100 is adapted to calculate the ratio of recyclables as compared to the sum of the recyclable, waste and any other materials associated with a user. The information relating to the diversion rate for the plurality of users is wirelessly transmitted to the central computer 112 in real time or substantially in real time, such that the central computer 112 has an up-to-date data record of the diversion rate for each user along a collection vehicle 110 route.

It follows that the central computer 112 may also be able to compute the current load for each collection vehicle 110 as well as the proportion of recyclables within that current load. As such, the system 100 of the present invention can provide the central computer 112 with data relating to the current and/or real-time load of each of the collection vehicles 110 deployed in the system 100. The real time data, in combination with historical data regarding the load and diversion rate for each of the users along a particular collection vehicle 110 route, can permit the central computer 112 to adjust, adapt, shorten, lengthen or otherwise modify the route in order to maximize the capacity of the collection vehicle 110. As before, this route adjustment and refinement can be done in real time through the coupling between each of the collection vehicles 110 and the central computer 112.

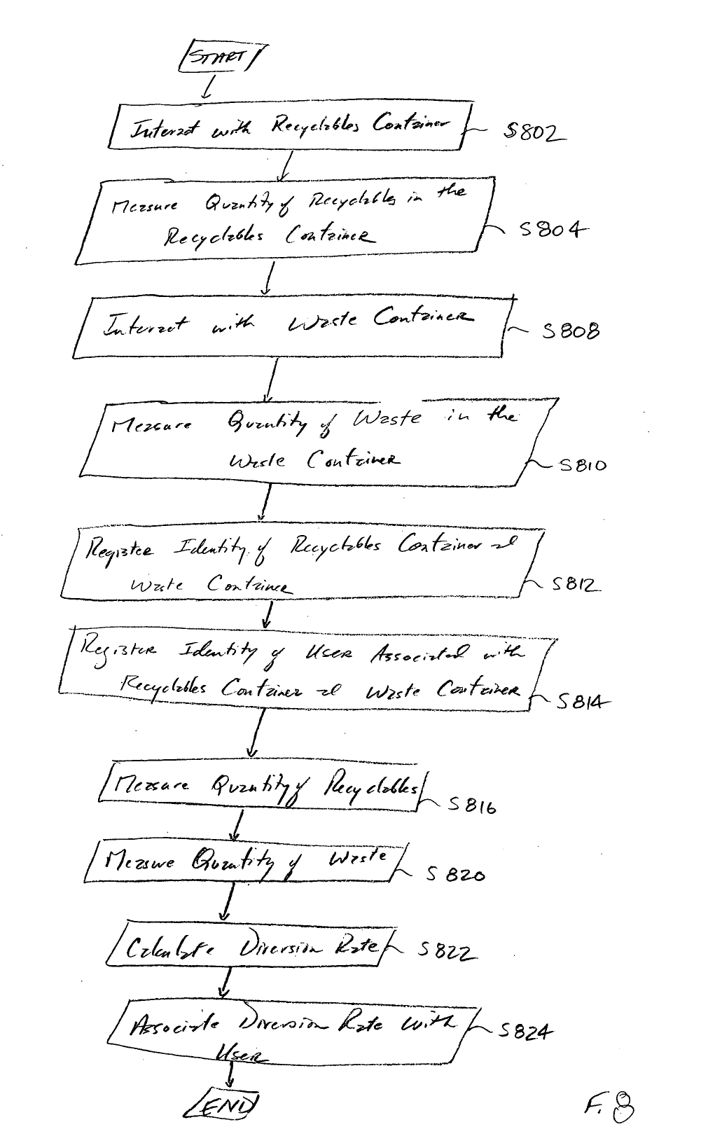

Turning to FIG. 6, the networking of the collection vehicles 110 with the central computer 112 may further allow the system 100 of the present invention to cooperate directly with the municipality 600 and its associated material recovery facilities (MRFs). For example, it is often the case that one or more MRFs located within or near a particular collection route will have differing hardware and recovery mechanisms. While some MRFs, such as MRF1, may be well suited for receiving aluminum recyclables, MRF2 and MRF3 may be better suited for receiving paper products or plastics for example. Moreover, each respective MRF may have a maximum throughput depending upon its configuration and recovery capacity. As such, the central computer 112, implementing data concerning the configuration and capacity of each respective MRF, can readily direct the plurality of collection vehicles 110 to that MRF that is best suited for receiving the materials contained therein. That is, the central computer 112 is further adapted to refine the routes of the collection vehicles 110 in response to data concerning the configuration, capacity or other characteristic of one or more MRFs associated with the collection service.

Route refinement through the central computer 112 is also possible along geographic regions as shown in FIG. 7. Likewise, it is a feature of the present invention that the central computer 112, in collection and processing the diversion rate data for a multitude of users, provides the municipality with the resource for configuring one or more MRFs according to the volume, type and geographic region of the recycling being collected. For example, MRF1 may be located in a particular region that has a high incidence of paper recycling, such as an area near one or more office complexes. As such, the central computer 112 will note through repeated collection cycles both the diversion rate, i.e. volume, of recycling as well as the type of recycling most commonly done. In response thereto, the municipality or collection service can configure MRF1 for a particular expected load of an expected type based on the historical data collected by the central computer 112. Similar adjustments or modifications to MRF2 and MRF3 can be made in response to the diversion rate data received by central computer 112 and processed according to geographic region.

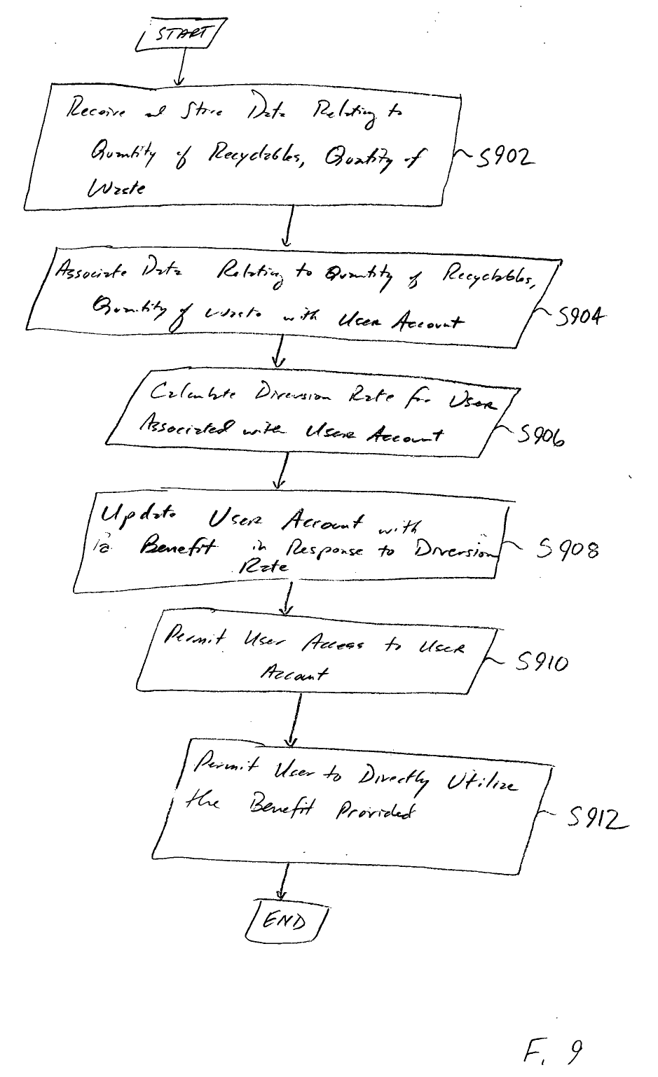

The system 100 of the present invention, described above, is best implemented according to the methodology of the present invention, set forth in the following Figures. A flow chart depicting a method of calculating a diversion rate is shown in FIG. 8. In step S802, the method calls for interacting with a recyclables container. As previously noted, this interaction can take many forms, and can be accomplished through automated means associated with a collection vehicle, as described above. In step S804, the method recites the step of measuring the quantity of recyclables in the recyclables container, which can be done through automated weighing means, such as a scale operating within or on a loading arm of the collection vehicle. In step S808, the method recites interacting with a waste container, and in step S810, the method recites the step of measuring the quantity of waste in the waste container. As in the prior steps, steps S808 and S810 are preferably performed according to the system 100 apparatus described in detail above.

In step S812, the method recites registering the identity of the recyclables and waste container, which includes the steps of receiving data or indicia from the recyclables and waste containers regarding the associated user. As noted above, the communication between the collection vehicle and the respective containers can take a plurality of forms, including identification through RFID, optical bar code, or other electronic or optoelectronic means. For example, each of the containers may be fitted with an RFID tag that emits a signal identifying the container and the user, the signal being readable by an RFID reader coupled to or otherwise associated with a particular collection vehicle. In step S814, the identity of the user is associated with the recyclables container and the waste container, that may involve the step of receiving the electronic data from such containers and matching it with a user identity and user account. The data processing and registration may take place within the on-board computer 120 on the collection vehicle, or it may be accomplished on the central computer 112, or both.

In step S816, the method recites measuring the quantity of recyclables, and in step S820 the method recites measuring the quantity of waste. These steps can be accomplished through either independently measuring the weight of each type of material within the collection vehicle, or alternatively, by subtracting out a known tare weight for the respective containers from the gross weight or quantity determined in steps S804 and S808, respectively. Given the quantity of both the waste and recyclables, the method calculates the diversion rate for a user in step S822.

As noted above, the diversion rate is defined as the ratio of the recyclables received as compared to the sum weight of the recyclables and the waste received. Thus, knowing the independent weight of either material, or knowing the gross weight of each container plus its respective material less the weight of the container, the diversion rate calculation can proceed. Preferably, the diversion rate calculation is performed by the central computer 112, such that the result can be readily associated with a user in step S824. Alternatively, the on-board computer 120 on each collection vehicle can be adapted for calculating the diversion rate for each and every user in a serial fashion along the collection route, with the data transmitted to the central computer 112 in real-time or within a substantially short interval. As noted above, collection of waste and recyclables is not necessarily performed by the same collection vehicle on the same day, and thus calculation of the diversion rate is largely dependent upon the timing of the collection.

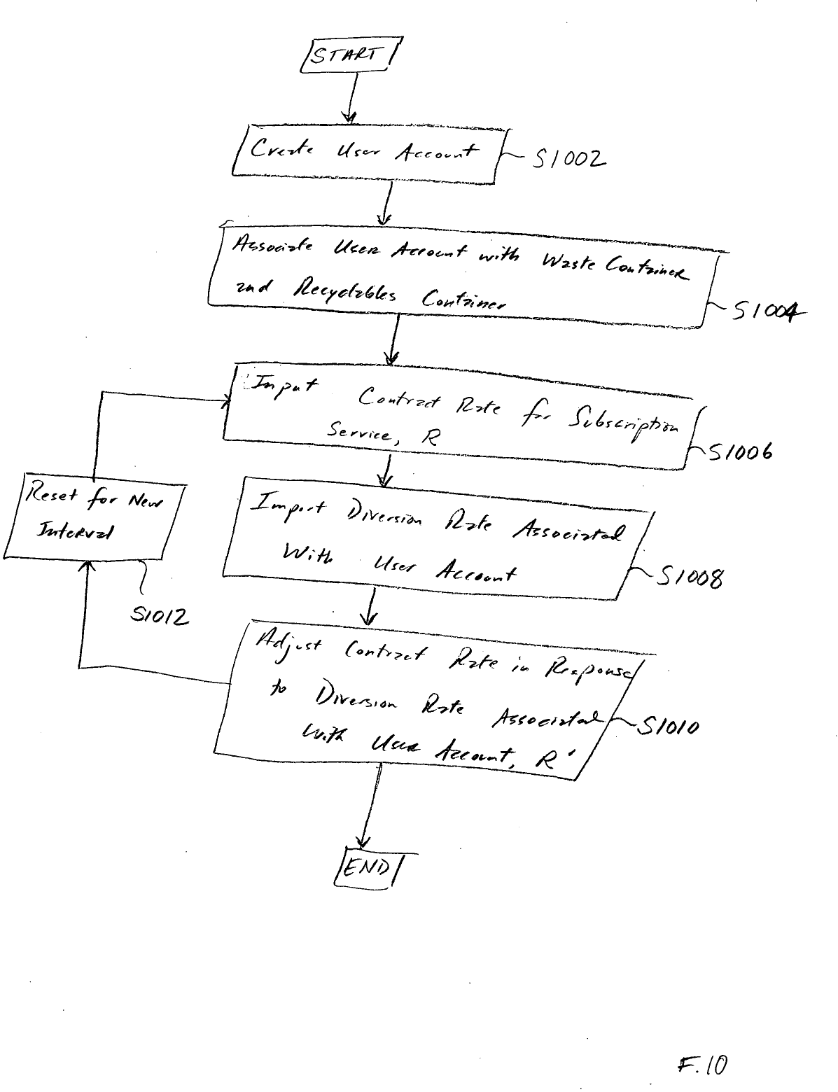

As shown above, the central computer 112 is in communication with a plurality of user accounts for a wide range of users, including residential users, commercial users and user consortiums. The method of the present invention therefore includes providing a benefit to a user as shown in FIG. 9. In step S902, the central computer 112 receives and stores data relating to the quantity of recyclables and quantity of waste, which is readily associated with a user and a user account as described above in step S904. The diversion rate is calculated as described above in step S906, and a benefit is provided to the user in response thereto in step S910.

The benefit provided can and should vary according to the type of user in order to provide a greater incentive for recycling. For example, individual users may be interested in benefits or rewards such as a reduction in the cost of the collection service or coupons for goods or services provided by third parties, such as for example household goods, grocery markets, and the like. By contrast, commercial users may be eligible benefits that reduce the cost of the collection service, or for coupons for third party goods or services such as office supplies, shipping services, and the like. Lastly, a user consortium may be interested in benefits that can be readily divided among a group, such as coupons, rebates or rate reductions in the collection service.

Once the benefit is determined, it is provided to the user in the user account, at which time the user may access the benefit through the user account as shown in step S910. As previously noted, the system 100 provides that users can access their accounts through a computer network, at which time they can view their account data and any rewards that may have been accumulated. In step S912, the method permits a users to directly utilize the benefit provided herein, which might entail downloading and printing a coupon, paying a portion of the collection service with reward points, or securing a collection service price reduction in response to an increased diversion rate.

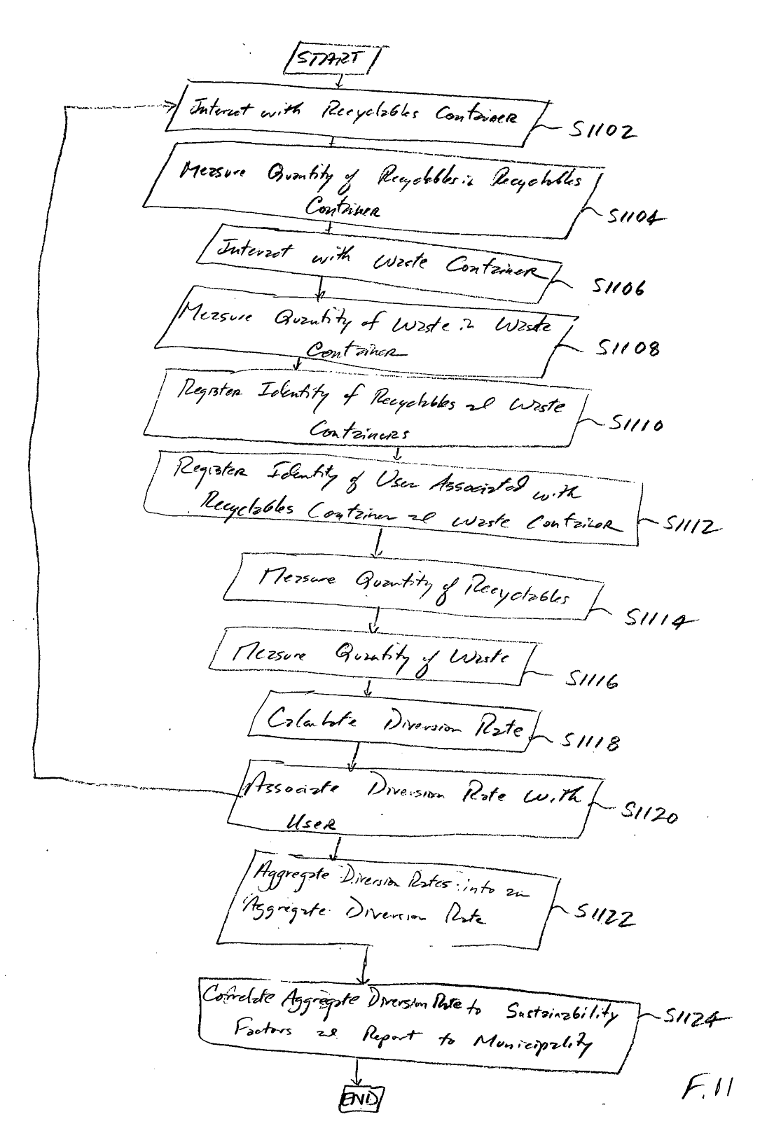

With regard to the latter benefit, FIG. 10 is a flow chart depicting a method for adjusting a contract rate for subscription-based collection services. In step S1002 a user account is created, which is then associated with a waste container and a recyclables container in step S1004. In step S1006, a contract rate for subscription service for a first time interval, R, is input into the central computer 112. The first interval may be determined according to the subscription service agreement, but it is preferable that the first interval be substantially identical to the billing period for the service, for example a monthly or quarterly interval. The diversion rate associated with the user account, measured and refined as stated above, is input into the central computer 112 in step S1008. In step S1010, the contract rate, R, is adjusted in response to the user diversion rate. In preferred embodiments, the new rate, R′, is adjusted up in response to a low diversion rate and down in response to a high diversion rate. The new rate, R′, is fed back in step S1012 into step S1006, wherein the new rate becomes the contract rate for the present interval, at which time the process is repeated. In summary, the method depicted herein constantly adjusts the rate at which a user is billed for its collection service, thereby providing incentive for the user to maximize its diversion rate.

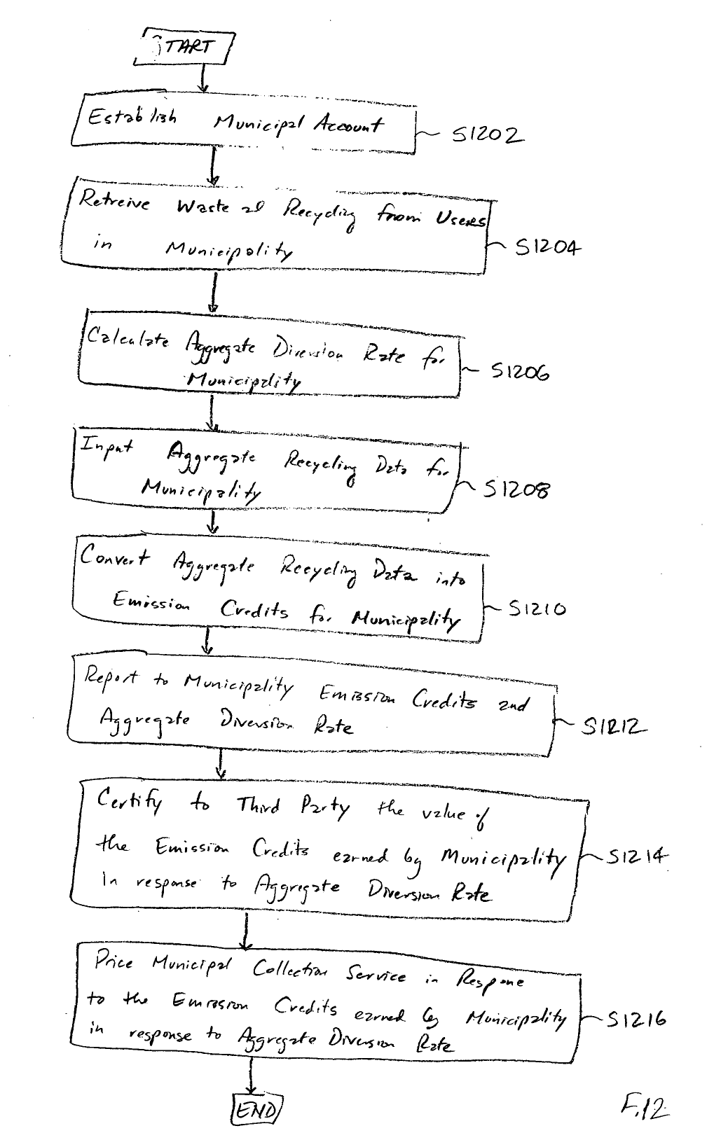

Turning to FIG. 11, a method for providing sustainability feedback to a municipal government is depicted according to the present invention. In step S1102, the method calls for interacting with a recyclables container. As previously noted, this interaction can take many forms, but it is preferably accomplished through automated means associated with a collection vehicle, as described above. In step S1104, the method recites the step of measuring the quantity of recyclables in the recyclables container, which is preferably done through automated weighing means, such as a scale operating within or on a loading arm of the collection vehicle. In step S1106, the method recites interacting with a waste container, and in step S1108, the method recites the step of measuring the quantity of waste in the waste container. As in the prior steps, steps S1106 and S1108 are preferably performed according to the system 100 apparatus described in detail above.

In step S1110, the method recites registering the identity of the recyclables and waste container, which includes the steps of receiving data or indicia from the recyclables and waste containers regarding the associated user. As noted above, the communication between the collection vehicle and the respective containers can take a plurality of forms, including identification through RFID, optical bar code, or other electronic or optoelectronic means. For example, each of the containers may be fitted with an RFID tag that emits a signal identifying the container and the user, the signal being readable by an RFID reader coupled to or otherwise associated with a particular collection vehicle. In step S1112, the identity of the user is associated with the recyclables container and the waste container, involving the step of receiving the electronic data from such containers and matching it with a user identity and user account. The data processing and registration may take place within the on-board computer 120 on the collection vehicle, or it may be accomplished on the central computer 112, or both.

In step S1114, the method recites measuring the quantity of recyclables, and in step S1116 the method recites measuring the quantity of waste. These steps can be accomplished through either independently measuring the weight of each type of material within the collection vehicle, or alternatively, by subtracting out a known tare weight for the respective containers from the gross weight or quantity determined in steps S1104 and S1108, respectively. Given the quantity of both the waste and recyclables, the method calculates the diversion rate for a user in step S1118.

The diversion rate is defined as the ratio of the recyclables received as compared to the sum weight of the recyclables and the waste received. Thus, knowing the independent weight of either material, or knowing the gross weight of each container plus its respective material less the weight of the container, the diversion rate calculation can proceed. Preferably, the diversion rate calculation is performed by the central computer 112, such that the result can be readily associated with a user in step S1120. Alternatively, the on-board computer 120 on each collection vehicle can be adapted for calculating the diversion rate for each and every user in a serial fashion along the collection route, with the data transmitted to the central computer 112 in real-time or within a substantially short interval. As previously noted, the collection of waste and recyclables may not be performed at the same time by the same collection vehicle 110, and as calculation of the diversion rate is largely dependent upon the timing of said collection it is common for the central computer 112 to perform that function.

As shown in FIG. 11, the diversion rate calculation process, steps S1102 to S1120 is repeated for each user located within the municipality or associated with a municipal collection service. In step S1122, the diversion rates are aggregated into an aggregate diversion rate through computations made by the central computer 112 and the system 100 described above. In step S1124, the aggregate diversion rate is made available to the municipality, and it is further correlated with a plurality of sustainability factors that permit the municipal government to make changes, improvements or otherwise alter or direct the collection service in response to the added environmental improvements. For example, a high aggregate diversion rate would tend to indicate improved recycling, and hence higher economic and ecological sustainability within the local environment, at which time the municipality may decide to adjust incentives for recycling.

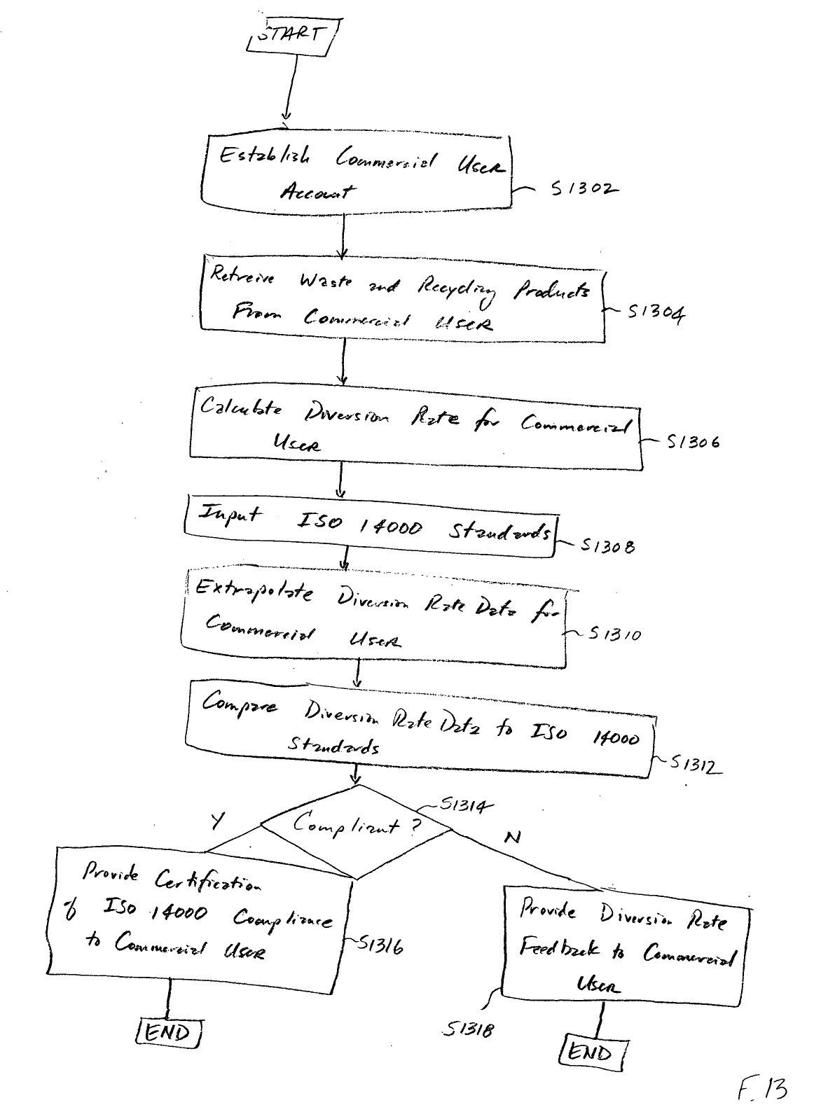

FIG. 12 is a flowchart detailing further aspects of the method of the present invention, in particular the use of the aggregate diversion rate described above as it relates to emission credits available from state and federal agencies. In step S1202, the method recites establishing a municipal account of the type described above with reference to the system 100 of the present invention. In step S1204, the process of waste retrieval and disposition is carried out in accordance with those steps described above and preferably consistent with the system 100 of the present invention. Step S1206 recites calculating an aggregate diversion rate for the municipality. The aggregate diversion rate is defined as the sum of the diversion rates for each user disposed within the municipality. As noted herein, the term user should be understood to include individual residential users, commercial users, user consortiums including apartment buildings, schools and other common facilities, and government users including local, state and federal government entities. The diversion rate for each user is computed according to the method described above, and then aggregated, preferably by the central computer 112 as part of the system 100 of the present invention.

In step S1210, the aggregate diversion rate for the municipality is converted into one or more emission credits, a step that is also preferably performed by the central computer 112. In doing so, the central computer 112 receives the aggregate diversion rate as an input, and from the total quantity of recycled items, computes a commensurate amount of fossil fuel emissions that are saved by not having to reproduce those items from inception. In doing so, the central computer 112 inputs an aggregate recyclables weight derived from the aggregate diversion rate, followed by inputting a correlated value between the manufacture or disposal of a recyclable good and a unit of fossil fuels utilized to manufacture or dispose of the recyclable good. Thereafter, the central computer correlates the aggregate recyclables weight into the emission credit value in response to the correlated value between the manufacture or disposal of a recyclable good and a unit of fossil fuels utilized to manufacture or dispose of the recyclable good.

Thus, the net energy saved from the extraction of raw materials, processing and manufacture of the recyclable goods is converted into an emission credit representing the savings in fossil fuel emissions to the environment. The emission credits are reported to the municipality along with the aggregate diversion rate in step S1212.

In using the emission credits and converting them into economic incentives for its residents, the municipality must confirm to regulatory authorities the actual environmental impact of its recycling endeavors. In step S1214, the method recites certifying to a third party the value of the emission credits earned by the municipality in response to the aggregate diversion rate. Interested third parties might include state and federal environmental agencies, such as for example the Environmental Protection Agency (EPA) and similarly situated bodies at the state or local level.

The economic effect of the emission credits is a net savings to the municipality through increased use of recycled goods, which can be sold as commodities through a market, as well as the indirect cost savings received through energy conservation, improved environmental health, and improved health and productivity of the workforce within the municipality. As such, those economic savings can be passed through to the taxpayer by pricing the municipal collection service in response to the emission credits earned by the municipality in step S1216. Thus, as the aggregate recycling rate increases, a myriad of economic and environmental benefits are accumulated and passed through to the taxpayer, who is typically a user of the collection service and system 100 of the present invention.

The present invention further includes a method for providing certain environmental compliance certification for users, and in particular for commercial users. It is common for commercial entities, particularly those in the industrial and manufacturing businesses, to apply for various certifications as to their business practices. Many of these compliance standards are promulgated by the International Organization for Standardization (ISO), which is well-known throughout the world for providing business practice and environmental standards. In particular, the ISO 14000 family of standards is related to environmental management systems, environmental auditing and environmental policy generally. Third party certification of those standards, particularly with respect to environmental management, may be submitted to the ISO itself in order to receive its compliance seal.

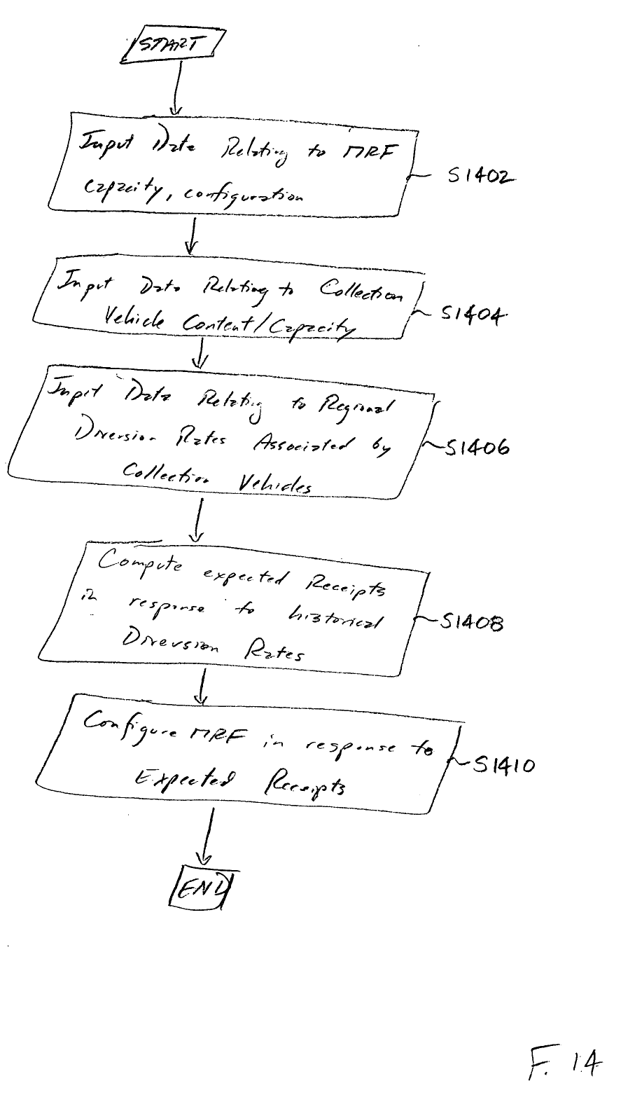

The method of the present invention includes steps for providing certification of ISO 14000 standards, as shown in FIG. 13. In step S1302, a commercial user account is established by a business entity seeking environmental standards compliance. In step S1304, the waste and recycling products are retrieved from the commercial user according to the system 100 and methods described in detail above. The diversion rate for the commercial user is calculated in step S1306 according to the method described herein, and preferably utilizing the system 100 of the present invention. In step S1306, the ISO 14000 standards are input into the central computer 112, wherein the diversion rate data for the commercial user is extrapolated in step S1310.

In step S1312, the diversion rate data is compared to the ISO 14000 standards where appropriate, i.e. with respect to environmental management, compliance and environmental audit requirements. Step S1314 queries whether the diversion rate is sufficient for compliance with the ISO 14000 standards, and if so the method directs the user to step S1316, wherein the method provides certification of ISO 14000 compliance to the commercial user for use in attaining its seal. If the diversion rate is insufficient for compliance with ISO 14000 standards, then the user is directed to step S1318, in which diversion rate feedback is provided to the commercial user in order to provide further guidance and instruction regarding the improvement of its environmental management practices and eventual compliance with the ISO 14000 family of standards.

As noted in describing the system 100 of the present invention, integration of the central computer 112 with a plurality of collection vehicles 110 as well as local and regional MRFs allows the system to alter or modify the routes and destination of those collection vehicles 110 in response to the status of each MRF. Similarly, the present invention includes a method for configuring one or more MRFs in response to current and historical data related to diversion rates in the region. FIG. 14 is a flow chart depicting such a method. Step S1402 recites inputting data relating to a MRF capacity and configuration into the central computer 112, including the systems and hardware operating within the MRF, its present status of operation, its throughput and its location. In step S1404, data relating to the collection vehicle content and capacity is input into the central computer 112, which includes real time or substantially real time data related to the gross quantity of recyclables and waste material within one or more collection vehicles 110.

In step S1406, the method recites inputting data relating to regional diversion rates associated by collection vehicle 110, i.e. the historical diversion rate for a region in order to anticipate the full load on a collection vehicle 110 serving that region. In step S1408, the method computes the expected receipts in response to the historical diversion rates for each collection vehicle or region, which is indicative of the gross amount of recyclable materials to be expected at the MRF. In response to the preceding inputs, the method configures the MRF in step S1410 in order to more efficiently and economically receive and process those recyclable materials received. By integrating real-time and historical data, the method of the present invention permits operators of a MRF to optimize the performance of its collecting, sorting and processing apparatus, thereby providing a maximum benefit to its operators and the community at large.

As described above in its various aspects, the present invention includes a system and methods for providing incentives for recycling, those incentives applying across a range of users and for a number of purposes. Notably, the present invention utilizes the diversion rate associated with each user for computing the net effect of the recycling behavior of each user, thereby having a more accurate and environmentally conscious measurement of the user's actions. Through the diversion rate calculations, the system and methods of the present invention provide a number of benefits, ranging from economic rewards and coupons to ISO certification for commercial entities, all of which serve to provide greater incentive for recycling, reduced energy consumption and improved environmental health and sustainability for a community.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1) A method for managing a recycling program comprising:
a) receiving waste materials from a user;
b) receiving recyclable materials from the user;
c) measuring a quantity of waste materials received;
d) measuring a quantity of recyclable materials received, and
e) calculating a user-specific diversion rate based upon the ratio of recyclable materials as compared to the sum of recyclable materials and waste materials.

2) The method of claim 1, wherein the user is a municipal resident and the recyclables and waste are collected under a contract with the municipality.

3) The method of claim 2, wherein the waste and recyclables are collected substantially simultaneously.

4) The method of claim 3, wherein the waste and recyclables are collected by an identical collection vehicle.

5) The method of claim 2, wherein the waste and recyclables are collected substantially sequentially.

6) The method of claim 2, wherein the user is identified by communications between an RFID tag and an RFID reader.

7) The method of claim 6, wherein the RFID tag is attachable to a recyclables container associated with the user.

8) The method of claim 6, wherein the RFID reader is disposable on a collection vehicle.

9) The method of claim 6, further comprising the step of associating a predetermined group of users with a predetermined group of RFID tags, thereby rendering computable the diversion rate for the predetermined group of users.

10) The method of claim 9, wherein the predetermined group of users includes a group of users associated with a region within the municipality.

11) The method of claim 2, wherein the user is identified by communications between a GPS receiver disposed within a collection vehicle and a GPS satellite.

12) The method of claim 11, wherein the user is identified in response to a predetermined position of the collection vehicle corresponding with a location of a recyclables container associated with the user.

13) The method of claim 1, further comprising the step of creating a diversion rate report indicative of an aggregate diversion rate for users located within the municipality.

14) The method of claim 13, further comprising the step of providing the diversion rate report to the municipality.

15) The method of claim 14, further comprising the step of reporting to the municipality a regional diversion rate indicative of a diversion rate for users located within specified regions within the municipality.

16) The method of claim 15, further comprising the step of allocating collection trucks to the specified regions within the municipality in response to the regional diversion rate.

17) The method of claim 15, further comprising the step of allocating resources at a plurality of MRFs in response to the regional diversion rate.

18) The method of claim 1, further comprising the step of calculating a diversion rate for a commercial user located within the municipality.

19) The method of claim 18, further comprising the step of certifying the commercial user as compliant with an environmental management standard in response to a predetermined diversion rate for the commercial user.

20) The method of claim 19, further comprising the step of providing certification of compliance with the environmental management standard to the commercial user.

21) The method of claim 13, further comprising the step of correlating the aggregate diversion rate to a plurality of sustainability factors; and further comprising the step of reporting the plurality of sustainability factors to the municipality.

22) The method of claim 13, further comprising the step of converting the aggregate diversion rate into an emission credit value corresponding to an amount of fossil fuels saved through the recycling of goods.

23) The method of claim 22, wherein a step f) following step e) comprises the step of inputting an aggregate recyclables weight.

24) The method of claim 23, wherein step f) further comprises the step of inputting a correlated value between the manufacture or disposal of a recyclable good and a unit of fossil fuels utilized to manufacture or dispose of the recyclable good.

25) The method of claim 24, wherein step f) further comprises the step of converting the aggregate recyclables weight into the emission credit value in response to the correlated value between the manufacture or disposal of a recyclable good and a unit of fossil fuels utilized to manufacture or dispose of the recyclable good.

26) The method of claim 22, further comprising the step of translating the emission credit value into a pecuniary value.

27) The method of claim 26, further comprising the step of determining a municipality pricing value for a retrieval service based in part upon the pecuniary value derived from the emission credit.

28) The method of claim 1, wherein the user is a subscriber to a waste and recyclables collection service.

29) The method of claim 28, wherein the waste and recyclables are collected substantially simultaneously.

30) The method of claim 29, wherein the waste and recyclables are collected by an identical collection vehicle.

31) The method of claim 28, wherein the waste and recyclables are collected substantially sequentially.

32) The method of claim 28, wherein the user is identified by communications between an RFID tag and an RFID reader.

33) The method of claim 32, wherein the RFID tag is attachable to a recyclables container associated with the user.

34) The method of claim 32, wherein the RFID reader is disposable on a collection vehicle.

35) The method of claim 28, wherein the user is identified by communications between a GPS receiver disposed within a collection vehicle and a GPS satellite.

36) The method of claim 28, wherein the waste and recyclables are contained in a single container.

37) The method of claim 28, wherein the waste is contained in a waste container and wherein the recyclables are contained in a recyclables container.

38) The method of claim 28, further comprising the step of pricing a subscription service to a user in response to the diversion rate associated with the user.

39) The method of claim 38, further comprising the steps of establishing a user account, identifying a waste container and a recyclables container associated with the user account, and setting a first value for a subscription service.

40) The method of claim 39, wherein the step of setting a first value for a subscription service includes the step of estimating an estimated diversion rate for the user associated with the user account.

41) The method of claim 40, further comprising the step of adjusting the first value in response to a calculated diversion rate at selected intervals.

42) The method of claim 41, wherein the step of adjusting the first value includes the step of increasing the first value in response to the calculated diversion rate being less than the estimated diversion rate; and further includes the step of decreasing the first value in response to the calculated diversion rate being greater than the estimated diversion rate.

43) The method of claim 41, wherein the selected intervals are quarterly.

44) The method of claim 41, wherein the selected intervals are monthly.

45) The method of claim 28, further comprising the step of establishing a user account accessible through a network through which the user can maintain a subscription service.

46) The method of claim 45, further comprising the step of updating the user account with information related to the user diversion rate and a correlated value of the subscription service.

47) The method of claim 28, further comprising the step of providing a benefit to the user in response to the user's diversion rate.

48) The method of claim 47, wherein the step of providing the benefit to the user includes the steps of establishing a user account, identifying a waste container and a recyclables container associated with the user account, and setting a first value for the benefit to the user.

49) The method of claim 48, wherein the step of setting a first value for the benefit to the user includes the step of estimating an estimated diversion rate for the user associated with the user account.

50) The method of claim 48, further comprising the step of adjusting the first value in response to a calculated diversion rate at selected intervals.

51) The method of claim 50, wherein the step of adjusting the first value includes the step of increasing the first value in response to the calculated diversion rate being less than the estimated diversion rate; and further includes the step of decreasing the first value in response to the calculated diversion rate being greater than the estimated diversion rate.

52) The method of claim 50, wherein the selected intervals are quarterly.

53) The method of claim 50, wherein the selected intervals are monthly.

54) The method of claim 47, further comprising the step of establishing a user account accessible through a network through which the user receives the benefit.

55) The method of claim 54, further comprising the step of updating the user account with information related to the user diversion rate and a correlated value of the benefit.

56) The method of claim 47, wherein the benefit to the user is a coupon for use in the purchase of goods or services.

57) The method of claim 54, wherein the benefit to the user is deliverable through the user account.

58) The method of claim 54, wherein the benefit to the user is deliverable via an email address associated with the user account.

59) A recycling management system comprising;
a) receiving and/or collecting waste materials from a user;
b) receiving and/or collecting recyclable materials from the user;
c) determining a quantity of waste materials received;
d) determining a quantity of recyclable materials received;
calculating a user-specific diversion rate based upon the ratio of recyclable materials as compared to the sum of recyclable materials and waste materials; and
receiving one or more quality-material report derived from stored data relating to the quantity of recyclable materials and quantity of waste materials received from the user, such that the user is able to influence the user-specific diversion rate.

60) A system for managing a recycling program comprising:
a) receiving waste materials from a user;
b) receiving recyclable materials from the user;
c) measuring a quantity of waste materials received;
d) measuring a quantity of recyclable materials received; and
calculating a user-specific diversion rate based upon the ratio of recyclable materials as compared to the sum of recyclable materials and waste materials.
